(19) United States
(12) Patent Application Publication
(10) Pub. No.: US 2025/0315705 A1
(43) Pub. Date: Oct. 9, 2025

(54) ML MODEL PIPELINE FOR QUBO-BASED ANNEALING WORKLOADS

(71) Applicant: Dell Products L.P., Round Rock, TX (US)

(72) Inventors: Amy N. Seibel, Newton, MA (US); Ítalo Gomes Santana, Rio de Janeiro (BR); Brendan Burns Healy, Haddonfield, NJ (US)

(21) Appl. No.: 18/627,272

(22) Filed: Apr. 4, 2024

(51) Int. Cl. G06N 10/20

(52) U.S. Cl. CPC G06N 10/20

(57) ABSTRACT

One example method includes using a first machine learning (ML) model L to select a set of Lagrangian weights λᵢ for each constraint i defined in a given Hamiltonian function, using λᵢ for every constraint i to compile the Hamiltonian function to a matrix, using a second ML model, trained with λᵢ and hardware telemetry, to make a best hardware Ω selection, selecting a set of hyperparameters Ψᵢ for a given QUBO, λᵢ, and Ω, and solving the given QUBO using the best hardware Ω and the set of hyperparameters Ψᵢ.

### FIELD OF THE INVENTION

Embodiments of the present invention generally relate to optimization problems. More particularly, at least some embodiments of the invention relate to systems, hardware, software, computer-readable media, and methods, for using a machine learning pipeline to solve problems such as quadratic unconstrained binary optimization problems.

### BACKGROUND

With respect to the solution of QUBO (quantum unconstrained binary optimization) problems, users do not have a good way of approximating hyperparameter values or choosing weights on constraints for their jobs. The hyperparameter and weight selection processes are currently manual, time consuming, and frequently confusing. In some cases, a manual process may not even be possible due to lack of awareness of the bounds of each hyperparameter or weight. As a result, users may simply rely on default hyperparameter values. While this approach may be expedient in terms of the relative ease with which a solution may be obtained, this approach may underutilize the annealing solving process for a given QUBO, even when that process might otherwise be able to locate better solutions and/or may be able to improve the speed with which a solution is obtained.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a relation between optimization problems and corresponding physical systems.

FIG. 2 discloses aspects of an example of a quantum annealing workflow.

FIG. 3 discloses an illustration of the embedding problem.

FIG. 4 discloses a comparison of simulated annealing and quantum annealing.

FIG. 5 discloses an example method according to an embodiment.

FIG. 6 discloses aspects of an example embodiment of a computing entity, which may comprise classical and/or quantum components, including annealers and/or other solvers, configured and operable to perform part, or all, of any of the disclosed methods, processes, and operations.

### DETAILED DESCRIPTION OF SOME EXAMPLE EMBODIMENTS

Embodiments of the present invention generally relate to optimization problems. More particularly, at least some embodiments of the invention relate to systems, hardware, software, computer-readable media, and methods, for using a machine learning pipeline to solve problems such as quadratic unconstrained binary optimization problems.

One example embodiment comprises a method, which may be implemented by an ML (machine learning) model in a pipeline configuration, for example. The method may facilitate selection of Langrangian weights, hardware, and hyperparameters, and thus enable efficient and effective solution of problems such as QUBOs (quadratic unconstrained binary optimization). One embodiment of such a method may comprise the operations: using a multiple regressor model L to select a set of Lagrangian weights λᵢ for each constraint i defined in a given Hamiltonian; using λᵢ for every constraint i predicted in the previous operation so as to compile the Hamiltonian function to a matrix; using an ML model, trained with λᵢ and hardware telemetry, to make a best hardware Ω selection; selecting a set of hyperparameters Ψᵢ for a given QUBO, λᵢ, and Ω; and, providing as feedback for the solution of further problems, one or more of the solved QUBO problems and the selected variables λᵢ, Ω, and Ψᵢ, so as to increase prediction quality progressively over the usage of the method. Note that ML (machine learning) models may be referred to herein as an ‘ML model’ or simply as a ‘model.’

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in anyway. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that the need for a user to manually choose weights on constraints added to a Hamiltonian, annealing hardware, and hyperparameters may be eliminated. An embodiment may implement one or more processes that a human is not capable of performing, such as hyperparameter selection, and weight selection. An embodiment may provide QUBO solutions that are improved relative to the QUBO solutions that would be obtained with human involvement in processes such as hyperparameter selection, and weight selection. Various other advantages of one or more example embodiments will be apparent from this disclosure.

### A. Context for an Example Embodiment

The following is a discussion of aspects of an example context for various embodiments of the invention. This discussion is not intended to limit the scope of the invention, or the applicability of the embodiments, in any way.

### A.1 QUBO Optimization Problems

A QUBO is a type of combinatorial optimization problem that enables many real-world problems to be encoded in the following format:

$$H ( x ) = {\sum }_{i < j} {q}_{i , j} {x}_{i} {x}_{j} + {\sum }_{i} {q}_{i} {x}_{i}^{2} = {x}^{T} Q x$$

Where x∈{0,1}ⁿ.

### A.2 Quantum Annealing

Quantum Annealing (QA) tries to interpolate between a static problem-independent Hamiltonian for which the ground state can be efficiently prepared, and a final Hamiltonian whose ground state yields the desired answer. The QA system then linearly interpolates between H₀ and H_{f} (H_{f}=Q).

$$H ( t ) = α ( t ) {H}_{0} + β ( t ) {H}_{f}$$

Where: H_{f} is the Hamiltonian of the problem to be solved.

This system represented by H(t) evolves following the time-dependent Schrodinger equation. The system is manipulated in the manner of creating a quantum tunneling effect that makes that the system converge closer to the ground state.

### A.3 Quantum Annealing Intuition

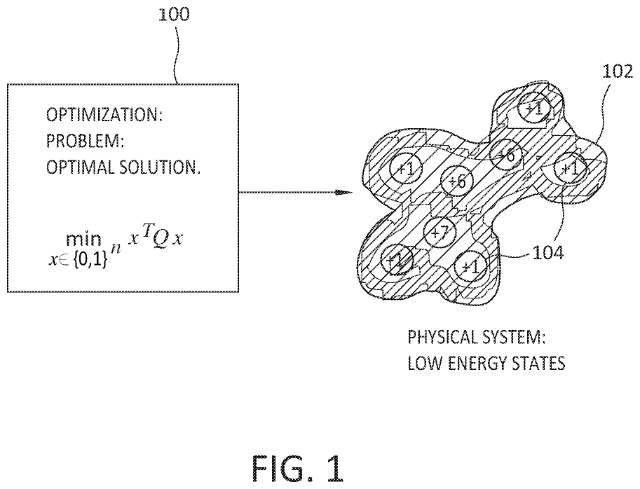

With reference briefly to FIG. 1, a solution to an optimization problem 100, such as a QUBO for example, may be thought of as being analogous to, or equating in some way to, a physical system 102. More specifically, the physical system 102 may have a variety of different low energy states 104, which may be referred to as local minima, each of which may comprise or corresponds to a respective solution to the optimization problem 100. The lowest energy state 104 may correspond to the optimal solution to the optimization problem 100.

### A.4 Example Quantum Annealing Workflow

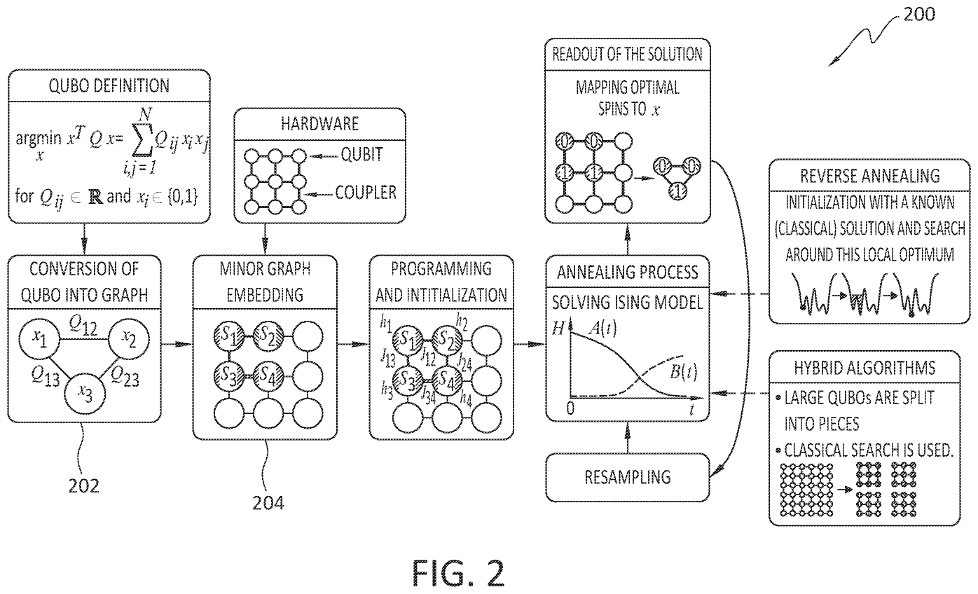

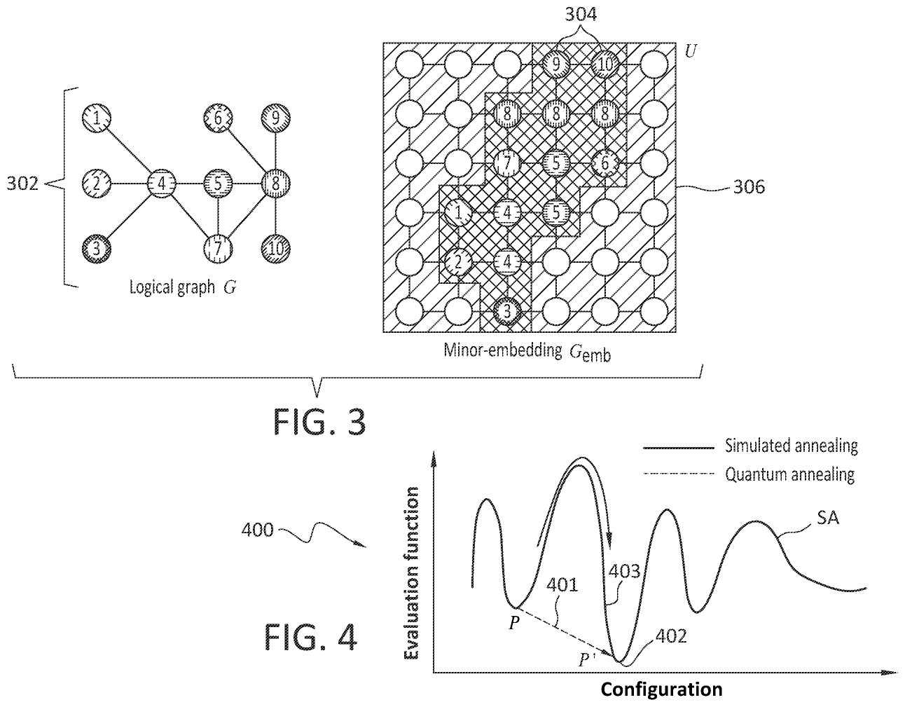

FIG. 2 discloses an example quantum annealing workflow 200. A conversion 202 of a QUBO into a graph may necessitate a graph embedding process 204 which may implicate a minor embedding problem, as disclosed in the example of FIG. 3.

### A.5 The Minor Embedding Problem

With reference now to FIG. 3, in order to solve combinatorial optimization problems such as QUBOs, it is necessary to map graph nodes 302, such as may be obtained at 202 in the example of FIG. 2, to the qubits 304 implemented in the hardware 306. In practice, heuristics may be used for this mapping. However, weak embeddings can drastically reduce the number of qubits in the hardware that are available for computation, which in turn may prevent the resolution of larger problem instances.

### A.6 Other Annealers

Simulated quantum annealing (SQA) refers to computational techniques used to simulate the physics of QA. SQA may be performed using classical computing, see, for example, https://tutorial.openjij.org/build/html/en/001-Introduction.html (OpenJiJ), classical accelerators as in the NEC vector annealing approach, or by creating specialized hardware to simulate the behavior of QA, as in the case of the Fujitsu hardware.

Simulated Annealing (SA) is a metaheuristic that resembles the annealing process on metallurgy where a QUBO can be encoded on the process of controlled cooling of a metal. SA can provide good solutions for a large range of problems but there is strong evidence that QA can find the global minimum, that is, solutions, of some problems exponentially more quickly than SA. For example, in the graph 400 in FIG. 4, it can be seen that the QA process reaches the global minimum 402 much more quickly than does the SA approach 403 because QA can leverage quantum effects such as tunneling during the search.

### B. Context for an Example Embodiment

Following is a discussion of a context for an example embodiment. This discussion is not intended to limit the scope of the invention in any way.

Solving optimization problems using QUBOs on quantum, or other, annealers may require various choices to be made. Following are some examples of such choices, listed in order of when during the process they may need to be made:
1. choice of weights on constraints added to Hamiltonian (and objective function);
2. choice of annealing hardware (example methods for selecting annealing hardware are disclosed in U.S. patent application Ser. No. 18/321,311 (the “'311 Application), incorporated herein in its entirety by this reference); and
3. choice of hyperparameters relevant to annealing hardware.

Appropriate selections at each of these stages may be important to the efficiency and effectiveness of the evaluation process. While the adjustment of these values may be necessary to obtain good results, it is difficult, if not impossible, for a human user to set proper values. For 1, and 3., for example, a guess-and-check method is typically employed such that locating optimal, or near-optimal, values is as computationally expensive as solving the QUBO problem itself. As well, for 3., involving sweeps, reads, and beta range, even the definition of those hyperparameters may be difficult for the user.

Following are some brief definitions for the aforementioned hyperparameters:
Reads: The number of times the annealer should independently run the execution, without needing to reform or reload the QUBO matrix;
Beta Range: The inverse of the temperature; that is, how sensitive the annealer or simulated annealer should be to changes in the energy landscape; and
Sweeps (simulation only): How many discrete steps to take around the energy landscape (read: number of times the set of spin values gets updated).
   In general, users typically lack have a good way to approximate hyperparameter values, or to choose weights on constraints for their jobs. The hyperparameter and weight selection processes are currently manual, time consuming, and frequently confusing. In some cases, a manual process may not even be possible due to lack of awareness on the part of the user of the bounds of each hyperparameter or weight. As a result, users may leave the default hyperparameter values in place, thereby underutilizing the annealing solving process in locating better solutions for the QUBO, and/or in speeding up the solution of a given QUBO.

### C. Aspects of an Example Embodiment

### C.1 Introduction

One example embodiment comprises a machine learning (ML) pipeline that includes the recommendation of weights on the problem constraints, QUBO placement on quantum or simulated annealers (see the '311 Application), and hyperparameters for such an annealer, that may improve operations by simplifying, and speeding up, the process of moving from problem identification, to problem solving. An aspect of one embodiment is that the outputs of one step or stage in the pipeline will be the inputs to the next stage, so the stages collectively form a connected system, rather than a disparate set of models intended to enhance a workflow.

### C.2 Overview of Aspects of an Example Embodiment

An example embodiment comprises a multi-stage ML pipeline, which may receive as input, a problem that comprises variables and constraints. The ML pipeline may, based on the problem, guide the selections required along the way to obtain results such as a solution to the input problem.

In one example embodiment, a multi-stage ML pipeline may comprise three models: (1) a first model operable to select Lagrangian weights on the constraints given inputs comprising the Hamiltonian constraints and objective function, and problem telemetry—such problem telemetry may include, but is not limited to, Hamiltonian size, number of variables, number of constraints, number of variables per constraint, and other factors which depends on the weight choices; (2) a second model operable to select a hardware, which may comprise an annealer or other solver, based on problem telemetry, including the QUBO compiled using the predicted Lagrangian weights; and, (3) a model operable to perform the selection of hyperparameter values, where the hyperparameters may comprise, but are not limited to, reads, sweeps, and beta range—it is noted that the hyperparameters relevant to the hardware selected by the third model may depend on hardware selection done in the second model, which also depends on an accurate definition of the Hamiltonian and its Lagrangian values selected by the first model.

In order to further refine the entire pipeline and its constituent models, individual jobs may be run multiple times. The performance of the pipeline may be judged by the final energy value of the solution, and positive results may be used in the models for improving their decisions. That is, models which output lower overall energy, after controlling for total Lagrangian weights, may be selected for inclusion in a feedback loop.

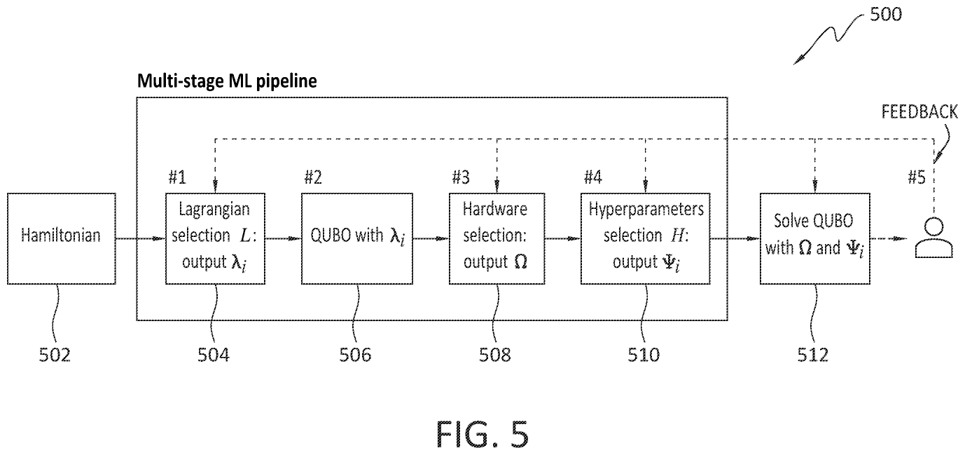

In general, and with reference now to the example ML pipeline 500 in FIG. 5, an example embodiment may begin with a given Hamiltonian function 502 as input, followed by a sequence of stages 504, 506, 508, and 510, within the ML pipeline 500 at which respective predictions are made, until a derived QUBO is solved 512. It is noted that the ML models that respectively implement the stages 504, 506, 508, and 510, may be trained on databases comprising high-quality executions in terms of performance and solution quality to benefit prediction quality. To further increase prediction, positive results after the QUBO resolution 512 may, in one embodiment, be employed for fine-tuning one or more of the models, and may be included in a dataset, such as an input dataset or a training dataset, for example, that may be used by one or more of the models.

### C.3 Detailed Discussion of Aspects of an Example Embodiment

As noted above, FIG. 5 discloses various stages of an example embodiment of an ML pipeline 500. Each of the example stages is discussed in turn below. In general, and as will discussed, an output of one stage may comprise part, or all, of the input of the succeeding stage(s), if any.

### C.3.1 Lagrangian Values Selector—Stage 1

The ML model of the first stage 504 of the example pipeline 500 may comprise a Lagrangian values selector. In the stage 504, a multiple regressor model L is used to select a set of Lagrangian weights λᵢ for each constraint i defined in the given input Hamiltonian 502. Each transaction of the training set for L may comprise a respective set of input features X related to the Hamiltonian and all λᵢ in its solving process as target variables. For example, X may express the number of binary variables, number of summations for the objective function and constraints, rate of monomials and binomials in each summation, among other features, while the target variables may comprise a Lagrangian value for each constraint. The output of stage 504 may be the set of Lagrangian weights λᵢ for each constraint i defined in the given input Hamiltonian 502.

### C.3.2 Compile QUBO—Stage 2

By using λᵢ for every constraint i predicted in the previous stage 504, the Hamiltonian function will, at stage 506, be compiled to a matrix. This matrix may be referred to herein as a QUBO matrix. In an embodiment, stage 506 omits the use of an ML model, and simply compiles the Hamiltonian function. As such, in an embodiment, the second ML model of the example pipeline 500 is deployed at stage 508.

### C.3.3 Hardware Selection—Stage 3

Some example approaches for hardware Ω selection 508 are disclosed in the '311 Application, and one of such approaches may operate as follows. An ML model comprising a multi-label chain classifier, or simply ‘classifier,’ may be trained over data extracted from past QUBO executions (input data) and annealers (target variable). At each QUBO problem given as test data to this classifier, a list of annealers is predicted that is sorted by a “best-fit” criterion. In an embodiment, this chain classifier may serve as a second ML model to select the best hardware Ω. And, in an embodiment, this ML model may be trained using, (A) as example input data, (1) the same training dataset employed at stage 504, (2) λᵢ, and (3) additional hardware telemetry, and (B) as a target variable, the hardware itself. In an embodiment, the hardware may comprise an annealer, or other solver. The output of stage 508 may be the selected hardware Ω.

### C.3.4 Hyperparameters Selector—Stage 4

At stage 510, a multiple regressor ML model H may be used to select a set of hyperparameters Ψᵢ, where such hyperparameters may comprise, for example, reads, sweeps and beta range for a given QUBO, λᵢ, and Ω. The training set may be seen as an extension of the training set of stage 506, with Ω as input data, and Ψᵢ as target variables. The output of stage 510 may be the selected hyperparameters Ψᵢ.

### C.3.5 Increasing Prediction Quality by Feedback—Stage 5

In an embodiment, an actor, or an automated process, may be introduced to provide feedback on all solved QUBO problems, along with the selected variables λᵢ, Ω, and Ψᵢ, to any ML model configured to increase prediction quality progressively over the usage of the solution.

### D. Further Discussion

As will be apparent from this disclosure, one or more embodiments may possess various useful aspects and advantages, although no embodiment is required to possess any of such aspects and advantages. The following examples are illustrative.

An embodiment may comprise a pipeline workflow for ML models relevant to a QUBO-based solution of an optimization problem, where the quality of the output is judged collectively, and outputs of one model directly affect inputs of the following model. An embodiment may provide a specialized constraint weight and a hyperparameter ML-based models specifically designed to work in an interdependency schema. As a final example, an embodiment may provide that prediction quality for each ML model may be increased by adding a feedback step, helping the schema, in this manner, to maintain these models updated over time.

### E. Example Methods

It is noted with respect to the disclosed methods, including the example method of FIG. 5, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments of the invention. These are presented only by way of example and are not intended to limit the scope of the invention in any way.

Embodiment 1. A method, comprising: using a first machine learning (ML) model L to select a set of Lagrangian weights λᵢ for each constraint i defined in a given Hamiltonian function; using λᵢ for every constraint i to compile the Hamiltonian function to a matrix; using a second ML model, trained with λᵢ and hardware telemetry, to make a best hardware Ω selection; selecting a set of hyperparameters Ψᵢ for a given QUBO, λᵢ, and Ω; and solving the given QUBO using the best hardware Ω and the set of hyperparameters Ψᵢ.

Embodiment 2. The method as recited in any preceding embodiment, wherein the first ML model L comprises a multiple regressor model.

Embodiment 3. The method as recited in any preceding embodiment, wherein the set of hyperparameters Ψᵢ comprises reads, beta range, and sweeps.

Embodiment 4. The method as recited in any preceding embodiment, wherein the best hardware Ω comprises an annealer.

Embodiment 5. The method as recited in any preceding embodiment, wherein the first ML model L was trained using a training set comprising a set of input features X related to the Hamiltonian function, and was trained with all of the Lagrangian weights λᵢ as target variables in a solving process performed by the first ML model.

Embodiment 6. The method as recited in any preceding embodiment, wherein the matrix comprises a QUBO matrix.

Embodiment 7. The method as recited in any preceding embodiment, wherein the a set of hyperparameters Ψᵢ is selected using a third ML model H.

Embodiment 8. The method as recited in embodiment 7, wherein the third ML model H comprises a multiple regressor model.

Embodiment 9. The method as recited in embodiment 7, wherein the third ML model H was trained using, as inputs, a same training set as was used to train the second ML model and hardware Ω, and was trained with the set of hyperparameters Ψᵢ as target variables.

Embodiment 10. The method as recited in any preceding embodiment, wherein one or more solved QUBO problems, including the given QUBO, and the Lagrangian weights λᵢ, best hardware Ω, and hyperparameters Ψᵢ, are provided as feedback for solution of a further QUBO problem, and the feedback increases prediction quality the next time the given QUBO is solved, and that feedback may be provided to further train one or more of the models in a multi-stage ML pipeline, so as to improve solutions for future QUBOs.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

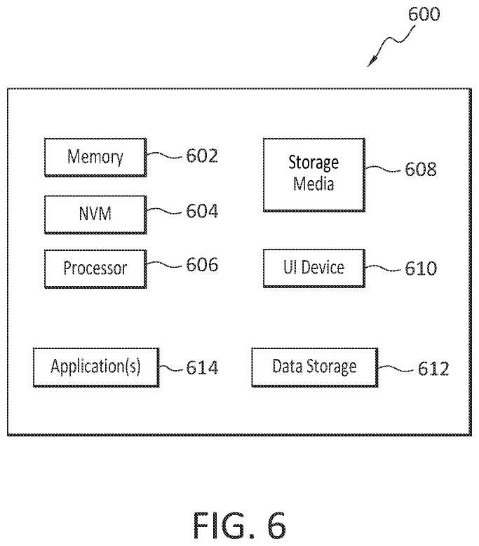

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

An embodiment of the computing device 600, or another computing device, may comprise quantum hardware, classical computing hardware, or a combination of quantum and classical computing hardware. By way of example, one embodiment may employ an annealer which may comprise, or consist of, classical computing components such as memory and processors for example. One embodiment may employ an annealer that comprises, or consists, of a quantum annealer. An annealer according to one embodiment may be a digital annealer, or a simulated annealer. No particular type or configuration of annealer is required in any embodiment however. In one embodiment, an explainer may comprise, or consist of, classical computing components.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
using a first machine learning (ML) model L to select a set of Lagrangian weights λᵢ for each constraint i defined in a given Hamiltonian function;
using λᵢ for every constraint i to compile the Hamiltonian function to a matrix;
using a second ML model, trained with λᵢ and hardware telemetry, to make a best hardware Ω selection;
selecting a set of hyperparameters Ψᵢ for a given QUBO, λᵢ, and Ω; and
solving the given QUBO using the best hardware Ω and the set of hyperparameters Ψᵢ.

2. The method as recited in claim 1, wherein the first ML model L comprises a multiple regressor model.

3. The method as recited in claim 1, wherein the set of hyperparameters Ψᵢ comprises reads, beta range, and sweeps.

4. The method as recited in claim 1, wherein the best hardware Ω comprises an annealer.

5. The method as recited in claim 1, wherein the first ML model L was trained using a training set comprising a set of input features X related to the Hamiltonian function, and was trained with all of the Lagrangian weights λᵢ as target variables in a solving process performed by the first ML model.

6. The method as recited in claim 1, wherein the matrix comprises a QUBO matrix.

7. The method as recited in claim 1, wherein the set of hyperparameters Ψᵢ is selected using a third ML model H.

8. The method as recited in claim 7, wherein the third ML model H comprises a multiple regressor model.

9. The method as recited in claim 7, wherein the third ML model H was trained using, as inputs, a same training set as was used to train the second ML model and hardware Ω, and was trained with the set of hyperparameters Ψᵢ as target variables.

10. The method as recited in claim 1, wherein one or more solved QUBO problems, including the given QUBO, and the Lagrangian weights λᵢ, best hardware Ω, and hyperparameters Ψᵢ, are provided as feedback for solution of a further QUBO problem, and the feedback increases prediction quality the next time the given QUBO is solved.

11. A non-transitory storage medium having stored therein instructions that are executable by one or more hardware processors to perform operations comprising:
using a first machine learning (ML) model L to select a set of Lagrangian weights λᵢ for each constraint i defined in a given Hamiltonian function;
using λᵢ for every constraint i to compile the Hamiltonian function to a matrix;
using a second ML model, trained with λᵢ and hardware telemetry, to make a best hardware Ω selection;
selecting a set of hyperparameters Ψᵢ for a given QUBO, λᵢ, and Ω; and
solving the given QUBO using the best hardware Ω and the set of hyperparameters Ψᵢ.

12. The non-transitory storage medium as recited in claim 11, wherein the first ML model L comprises a multiple regressor model.

13. The non-transitory storage medium as recited in claim 11, wherein the set of hyperparameters Ψᵢ comprises reads, beta range, and sweeps.

14. The non-transitory storage medium as recited in claim 11, wherein the best hardware Ω comprises an annealer.

15. The non-transitory storage medium as recited in claim 11, wherein the first ML model L was trained using a training set comprising a set of input features X related to the Hamiltonian function and all of the Lagrangian weights λᵢ as target variables in a solving process performed by the first ML model.

16. The non-transitory storage medium as recited in claim 11, wherein the matrix comprises a QUBO matrix.

17. The non-transitory storage medium as recited in claim 11, wherein the set of hyperparameters Ψᵢ is selected using a third ML model H.

18. The non-transitory storage medium as recited in claim 17, wherein the third ML model H comprises a multiple regressor model.

19. The non-transitory storage medium as recited in claim 17, wherein the third ML model H was trained using, as inputs, a same training set as was used to train the second ML model and hardware Ω, and with the set of hyperparameters Ψᵢ as target variables.

20. The non-transitory storage medium as recited in claim 11, wherein one or more solved QUBO problems, including the given QUBO, and the Lagrangian weights λᵢ, best hardware Ω, and hyperparameters Ψᵢ, are provided as feedback for solution of a further QUBO problem, and the feedback increases prediction quality the next time the given QUBO is solved.
